(19) United States
(12) Patent Application Publication
(10) Pub. No.: US 2025/0173561 A1
(43) Pub. Date: May 29, 2025

(54) TUNING LARGE LANGUAGE MODELS FOR NEXT SENTENCE PREDICTION

(71) Applicant: QUALCOMM Incorporated, San Diego, CA (US)

(72) Inventors: Carl Alexander BLACKLOCK, Toronto (CA); Sahil GUPTA, San Diego, CA (US); Veluppillai ARULESAN, Concord (CA); Jeffrey Baginsky GEHLHAAR, San Diego, CA (US); Kanghwan JANG, San Diego, CA (US); Pranav SHRESTHA, San Diego, CA (US); Hariharan SUKUMAR, San Diego, CA (US); Jian WANG, Thornhill (CA)

(21) Appl. No.: 18/522,149

(22) Filed: Nov. 28, 2023

(51) Int. Cl. G06N 3/08

(52) U.S. Cl. CPC G06N 3/08

(57) ABSTRACT

A processor-implemented method includes generating a group of single-head attention (SHA) operations based on a number of attention heads in a multi-head attention (MHA) mechanism, each SHA operation corresponding to a respective attention head of a group of attention heads associated with the MHA mechanism. The method also includes parallelly executing each of one of the group of SHA operations independently between hardware blocks of a device associated with a neural network model. The method further includes generating an MHA output based on parallelly executing each of one of the group of SHA operations.

### FIELD OF THE DISCLOSURE

Aspects of the present disclosure generally relate to neural networks, and more particularly to tuning a large language model for next sentence prediction.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Given the many useful applications of neural networks, there is increasing demand for use of neural networks to solve increasingly complex problems in further areas of application. One area of exploration is generative artificial intelligence. Large language models (LLMs) have made significant advances in the natural language understanding domain, and have gained popularity with respect to textual generative tasks as well as tasks that involve modelling information from textual and visual domains. LLMs may receive a prompt from a user, and in turn, may generate a response or completion.

### SUMMARY

In one aspect of the present disclosure, a processor-implemented method includes generating a group of single-head attention (SHA) operations based on a number of attention heads in a multi-head attention (MHA) mechanism, each SHA operation corresponding to a respective attention head of a group of attention heads associated with the MHA mechanism. The processor-implemented method further includes parallelly executing each of one of the group of SHA operations independently between hardware blocks of a device associated with a neural network model. The processor-implemented method also includes generating an MHA output based on parallelly executing each of one of the group of SHA operations.

Another aspect of the present disclosure is directed to an apparatus including means for generating a group of single-head attention (SHA) operations based on a number of attention heads in a multi-head attention (MHA) mechanism, each SHA operation corresponding to a respective attention head of a group of attention heads associated with the MHA mechanism. The apparatus further includes means for parallelly executing each of one of the group of SHA operations independently between hardware blocks of a device associated with a neural network model. The apparatus also includes means for generating an MHA output based on parallelly executing each of one of the group of SHA operations.

In another aspect of the present disclosure, a non-transitory computer-readable medium with non-transitory program code recorded thereon is disclosed. The program code is executed by a processor and includes program code to generate a group of single-head attention (SHA) operations based on a number of attention heads in a multi-head attention (MHA) mechanism, each SHA operation corresponding to a respective attention head of a group of attention heads associated with the MHA mechanism. The program code further includes program code to parallelly execute each of one of the group of SHA operations independently between hardware blocks of a device associated with a neural network model. The program code also includes program code to generate an MHA output based on parallelly executing each of one of the group of SHA operations.

Another aspect of the present disclosure is directed to an apparatus having one or more processors, and one or more memories coupled with the one or more processors and storing instructions operable, when executed by the one or more processors, to cause the apparatus to generate a group of single-head attention (SHA) operations based on a number of attention heads in a multi-head attention (MHA) mechanism, each SHA operation corresponding to a respective attention head of a group of attention heads associated with the MHA mechanism. Execution of the instructions also cause the apparatus to parallelly execute each of one of the group of SHA operations independently between hardware blocks of a device associated with a neural network model. The Execution of the instructions further cause the apparatus to generate an MHA output based on parallelly executing each of one of the group of SHA operations.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network, in accordance with various aspects of the present disclosure.

FIG. 2D is a diagram illustrating an exemplary deep convolutional network (DCN), in accordance with various aspects of the present disclosure.

FIG. 3 is a block diagram illustrating an exemplary deep convolutional network (DCN), in accordance with various aspects of the present disclosure.

FIG. 4 is a block diagram illustrating an exemplary software architecture that may modularize artificial intelligence (AI) functions, in accordance with various aspects of the present disclosure.

FIGS. 5 and 6 are diagrams illustrating token generation models, in accordance with various aspects of the present disclosure.

FIG. 7 is a flow diagram illustrating an example of a process for processing a multi-head attention (MHA) input by an MHA mechanism of a transformer model, in accordance with various aspects of the present disclosure.

FIG. 8 is a flow diagram illustrating an example process for parallel processing an MHA input by multiple single-head attention (SHA) mechanisms of a transformer model, in accordance with various aspects of the present disclosure.

FIG. 9 is a flow diagram illustrating an example of a process for generating an SHA mechanism from an MHA mechanism associated with a transformer model, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Large language models (LLMs) are examples of models that understand natural language. LLMs have gained popularity with respect to textual generative tasks as well as tasks that involve modeling information from textual and visual domains.

In many cases, an LLM uses a transformer (e.g., transformer model) based architecture to process sequences of data, particularly text. In an LLM, the transformer receives a sequence of tokens, which could be, for example, words, parts of words, or characters, and processes the tokens through its layers. As the data flows through each layer, the model learns increasingly complex representations of the input data. This allows the LLM to perform a wide range of language-related tasks, such as text completion, translation, summarization, and question-answering, with a high degree of fluency and coherence.

An attention layer (e.g., attention head) of the transformer determines parts of the input that are important and how these parts should influence the prediction tasks. The attention head processes data with a shape [sequence length, depth]. That is, for each position in the input sequence (the sequence length), the attention head processes a vector with a certain size (the depth). This vector represents the features or the encoded information of each position in the sequence. In some cases, the attention head may use a multi-head attention (MHA) mechanism to process and understand the input data in a parallel and comprehensive manner. The MHA mechanism may also be referred to as the MHA (used interchangeably). In such cases, the MHA processes data with a shape [number of heads, sequence length, depth]. The MHA mechanism improves the capabilities of a single-head attention (SHA) mechanism by allowing simultaneous processing across multiple heads. The SHA mechanism may also be referred to as the SHA (used interchangeably). The core calculation for the SHA can be expressed as: Attention=V*softmax(Q*K^{T}), where the parameter Q represents queries, the parameter K represents keys, and the parameter V represents values. The MHA mechanism augments the SHA by introducing parallelism, allowing the transformer to simultaneously attend to different parts of the input, which can improve the transformer's ability to capture various aspects of the input data. Specifically, the SHA focuses on a single set (query, key, and value), and the MHA splits this focus across multiple sets, each set potentially capturing different contextual nuances from the input sequence.

For example, in the context of natural language processing, each head may focus on different types of relationships between words, such as, for example, syntactic versus semantic relationships. This enables the transformer to have a more comprehensive understanding of the text. However, the use of multiple heads comes with a drawback with respect to the efficiency of a neural signal processor (NSP), which processes neural network operations. In most cases, various computations of the MHA may be processed on specialized hardware cores within the NSP. For example, matrix multiplications may be assigned to a hardware core optimized for such operations, whereas the softmax function, which normalizes the attention weights, might be processed on a vector-processing core. The use of multiple specialized cores can lead to inefficiencies. The need to reshape and transpose data tensors for different stages of the MHA computation may also lead to additional computational overhead. These extra steps increase an amount of processing power and time specified for performing the attention operations, potentially slowing down the overall computation and reducing the throughput of the NSP. Furthermore, the increased complexity of managing data across different cores may increase power consumption and may necessitate more sophisticated hardware designs to maintain efficiency.

Various aspects of the present disclosure are directed to improving the MHA by dividing the MHA into individual SHA operations. In some examples, each SHA operation may be executed independently to enable parallelization between hardware blocks, thereby reducing a number of reshape and transpose layers.

Specifically, the MHA allows the transformer to remember and focus on different parts of the text as the transformer generates or processes language, enabling the transformer to maintain context over longer passages and understand subtle nuances in language. The MHA may generate three vectors from the input data: queries (Q), keys (K), and values (V). The attention layer may use these vectors to create a set of attention scores based on comparing queries to keys. These scores, after being normalized using a softmax function, determine an amount of focus (e.g., ‘attention’) that should be given to corresponding values. The result is a weighted sum of the value vectors, which carries both the original information and the context obtained from the attention process. The model may simultaneously perform this operation based on the use of multiple heads.

Particular aspects of the subject matter described in this disclosure can be implemented to realize one or more of the following potential advantages. In some examples, the described techniques of decomposing MHA into independent SHA operations may improve computational efficiency. Specifically, these techniques may increase data throughput by reducing a lifetime of data in local memory and distributing the data transfer load more evenly across memory resources. Additionally, the described methods may decrease the necessity for data reshaping and transposing, thus potentially reducing the computational overhead and improving an overall speed of the attention mechanism within a transformer.

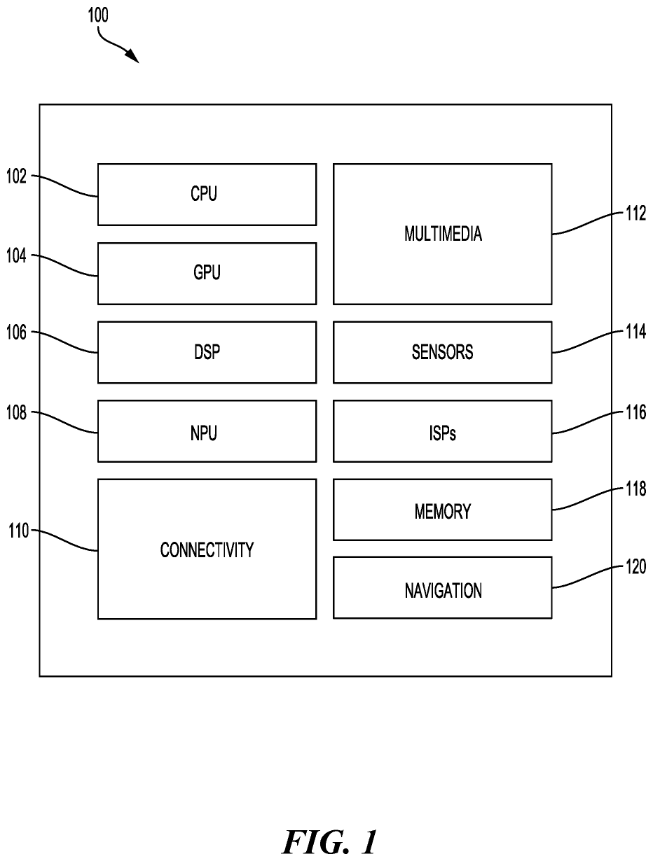

FIG. 1 illustrates an example implementation of a system-on-a-chip (SOC) 100, which may include a central processing unit (CPU) 102 or a multi-core CPU configured fortuning large language models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to generate a group of single-head attention (SHA) operations based on a number of attention heads in a multi-head attention (MHA) mechanism, each SHA operation corresponding to a respective attention head of a group of attention heads associated with the MHA mechanism; code to parallelly execute each of one of the group of SHA operations independently between hardware blocks of a device associated with a neural network model; and code to generate an MHA output based on parallelly executing each of one of the group of SHA operations.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

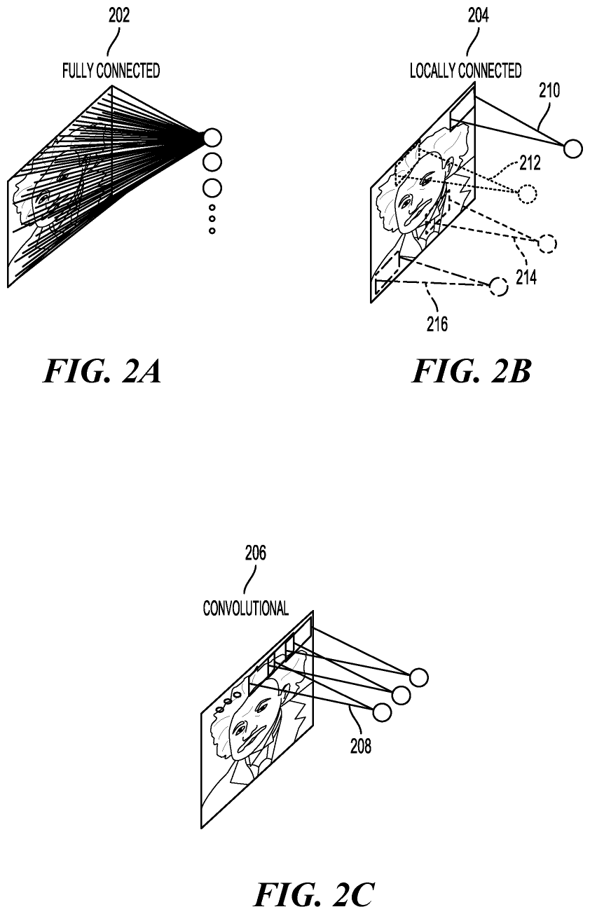

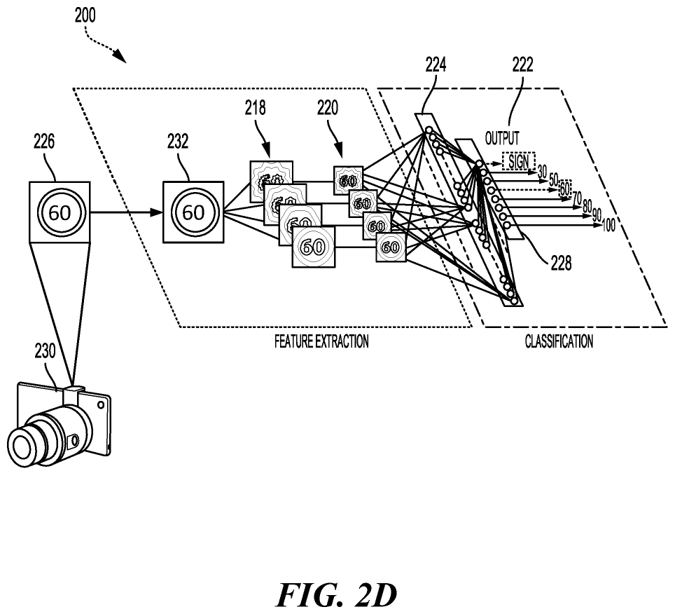

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

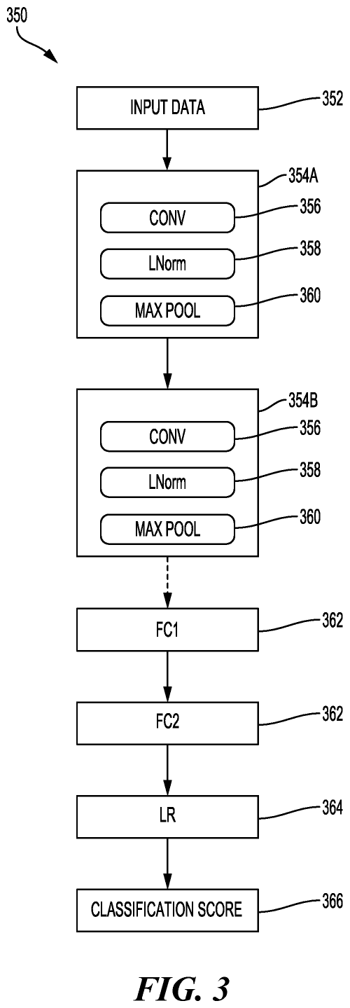

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

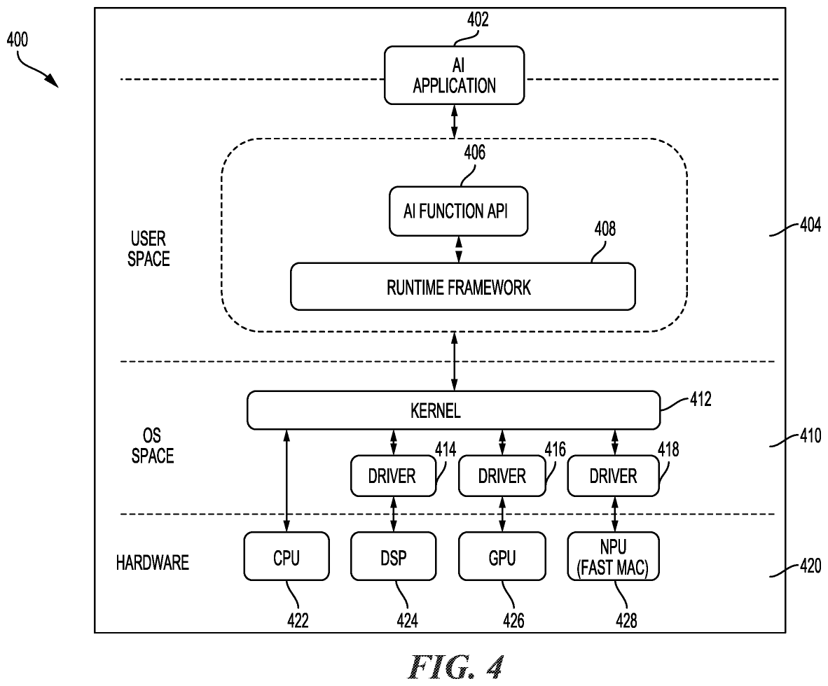

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support tuning large language models for next sentence prediction (NSP) for an AI application 402, according to aspects of the present disclosure. The architecture 400 may, for example, be included in a computational device, such as a smartphone.

The AI application 402 may be configured to call functions defined in a user space 404 that may, for example, provide an LLM, process an input for an LLM, or provide a generative AI application. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a run-time framework, may be further accessible to the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause LLM tuning to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

Large language models (LLMs) are examples of models that understand natural language. LLMs have gained popularity with respect to textual generative tasks as well as tasks that involve modeling information from textual and visual domains.

In many cases, an LLM uses a transformer (e.g., transformer model) based architecture to process sequences of data, particularly text. In an LLM, the transformer receives a sequence of tokens, which could be, for example, words, parts of words, or characters, and processes the tokens through its layers. As the data flows through each layer, the model learns increasingly complex representations of the input data. This allows the LLM to perform a wide range of language-related tasks, such as text completion, translation, summarization, and question-answering, with a high degree of fluency and coherence.

In an LLM, token generation begins with tokenization, where an input text is segmented into tokens, which could be complete words, subwords, or even individual characters, forming the basic units the model can interpret. These tokens are then transformed into numerical vectors through an embedding process, which captures and encodes the semantic significance of each token into a format the model can process.

Due to a transformer's lack of inherent sequence processing capability, positional encodings are added to these embeddings to provide the model with the sequence order information. The tokens are then input to the transformer's layers, each including an MHA and a feed-forward network. This MHA enables the model to weigh the importance of different parts of the input sequence selectively, refining its focus based on the relevance to the current processing point.

A final layer may generate a set of output vectors, each vector representing the model's contextual understanding. To predict the next token, the output vector for the current endpoint is passed through a dense layer equipped with a softmax activation. This produces a probability distribution over the entire vocabulary, indicating the likelihood of each token following the existing sequence. Choosing the subsequent token can be deterministic, using an ArgMax function to select the most probable token, or stochastic, introducing an element of randomness by sampling from the distribution. The process continues iteratively, with each newly predicted token being added to the sequence and the model re-engaging with the expanded input until a predefined stopping criterion is reached. This recursive process allows LLMs to generate text sequences that are contextually rich, coherent, and often strikingly similar to text produced by humans.

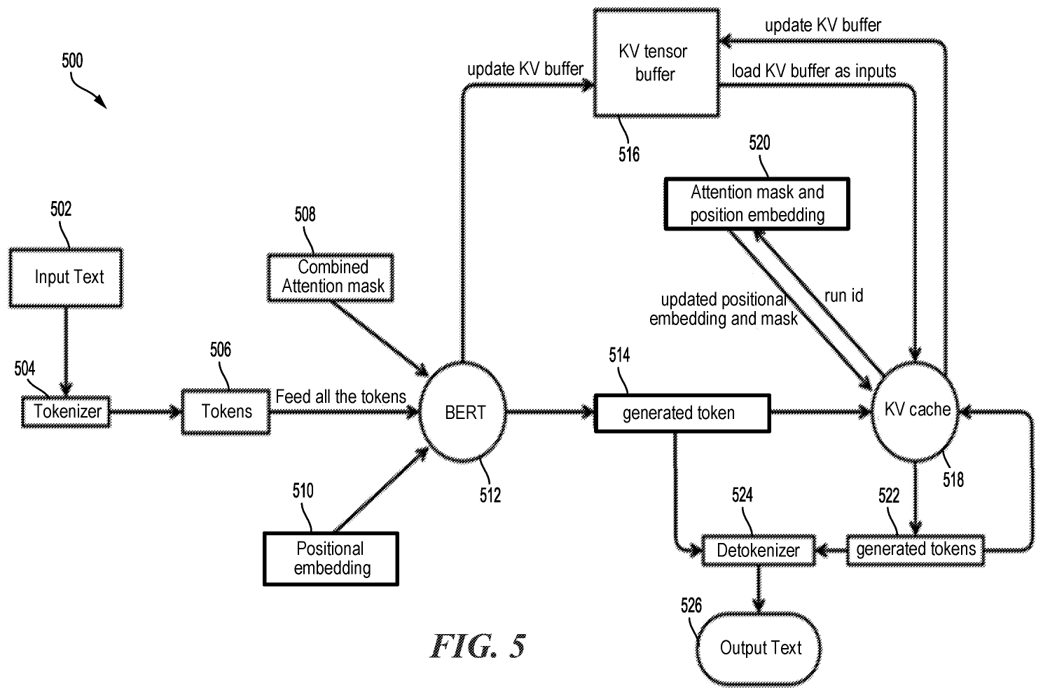

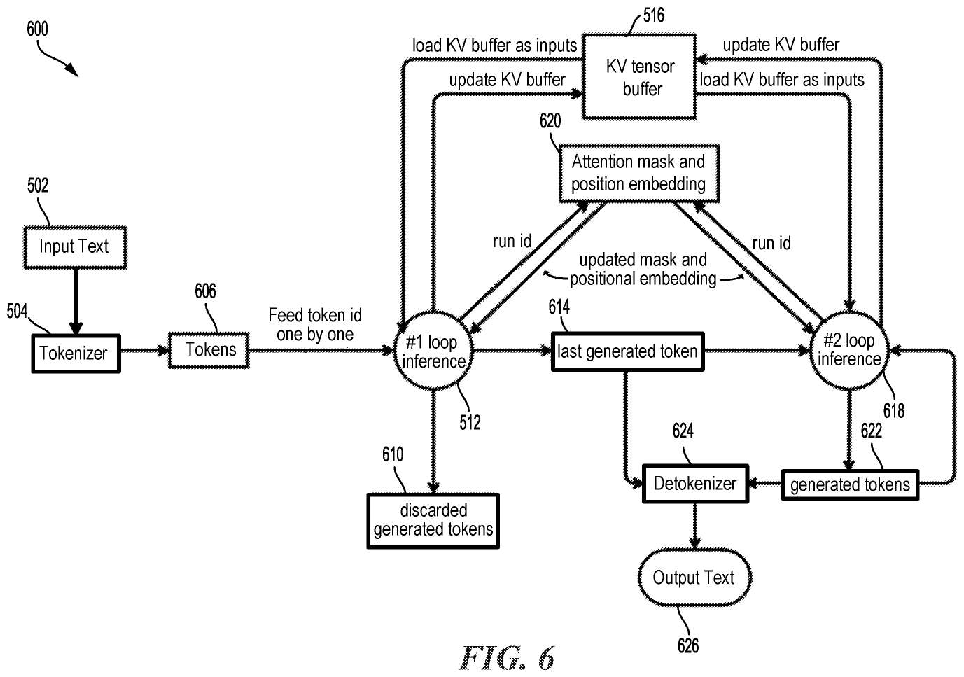

FIGS. 5 and 6 are diagrams illustrating token generation models, in accordance with various aspects of the present disclosure. FIG. 5 illustrates an example of a first KV model 500 that provides a pipeline for token generation for a large language model (LLM) 512. Because some neural processors such as the NPU 108 may only support static models with fixed input shape, the first KV model 500 may fix the input shape according to a maximum input length. In doing so, the first KV model 500 may take the data of the user prompt (e.g., valid data) and add padding (e.g., zeros) of the remaining portion of the input such that the input size may be fixed at the maximum length (e.g., 1024 characters).

The first KV model 500 may receive input text 502. The input text 502 may include a system prompt and a user prompt. The system prompt may be a standard prompt that may, for instance, indicate a greeting and/or an instruction to a user for operating the model (e.g., “please enter a question”). The user prompt may comprise the user input such as a task for the LLM. The user prompt may have a variable length.

The input text 502 may be provided to a tokenizer 504. The tokenizer 504 may divide the input text 502 into multiple portions referred to as tokens 506. A token 506 may comprise a subpart of the input text 502, such as sequence of characters (e.g., a token may be on average about four characters in length), a word, or a phrase. In the first KV model 500, the tokenizer 504 processes the input text 502 that may include, but is not limited to, a word, a sentence, a paragraph, or a document, for example, and may generate all of the tokens 506 for the input text 502. Then, the tokenizer 504 may provide all of the tokens 506 to the LLM 512 at once.

A position embedding 510 may be applied to maintain information related to the order of the tokens 506. An attention mask 508 may also be applied to identify more salient tokens (e.g., 506) corresponding to the input text 502. In turn, the LLM 512 may generate a prediction of a single following token 514. The generated token 514 may be considered a completion, for example, a following word in a response or output. The LLM 512 may be configured to generate multiple tokens 514 in an autoregressive manner by writing the generated token 514 to memory, such as a KV tensor buffer 516 to retain the internal state KV$ (e.g., a data structure referred to as KV cache, which may represent keys (K) and values (V) of the previously generated token) 518. The internal state KV$ 518 may be read from the KV tensor buffer 516 and appended to the previous input tokens 506. Attention mask and position embeddings 520 may be updated and supplied as input to the internal state KV$ 518. As the LLM 512 generates each token 514, the generated token 514 may be processed by a detokenizer 524 in a reciprocal manner to the tokenizer 504 to generate output text 526 (e.g., a sequence of characters, words, or phrases). The process may continue to be repeated in this manner. With each iteration, the generated token 522 may update the internal state KV$ 518 and may be written to the KV tensor buffer 516 to update the KV tensor buffer 516, which may, in turn, be loaded as the following input.

FIG. 6 shows a Second KV model 600 for token generation. The Second KV model 600 includes similar components as the first KV model 500 described with reference to FIG. 5. However, in FIG. 6, the Second KV model 600 may supply tokens 606 to the LLM 512 one token at a time rather than all tokens at once. In the Second KV model 600, there is one input, the token 606, and the LLM 512 generates a first inference, shown as a last generated token 614, which may be detokenized to generate one output 626. The KV tensor buffer 516 may be updated based on the last generated token 614 and the generated token may be discarded at block 610. The next token 606 corresponding to the inputs may be received and may be appended to the internal state loaded from the KV tensor buffer 516 to generate a second token 622 at a second inference 618, which may be detokenized by a detokenizer 524, and output as output 626. Then, the KV tensor buffer 516 may be updated based on the last generated token 614 and the generated token may be discarded at block 610. The process may repeat until all of the tokens 606 corresponding the input are looped in and processed by the LLM 512.

In summary, the first KV model 500 shown with respect to FIG. 5 takes all of the input prompts (e.g., tokens 506) at one time and generates the first token and the KV cache of the input prompt. On the other hand, the Second KV model 600 takes all of the input prompts one token at a time and generates the first token and KV cache of the prompt. As such, the first token latency for the Second KV model 600 may be less than the first token latency for the first KV model 500. Because the first KV model 500 takes all inputs prompts (e.g., system prompt and user prompt) at one time, the input dimensions may be fixed at a maximum length (e.g., 1024 characters). Thus, the first token latency for the first KV model 500 may also be fixed at the time for processing the maximum input length (e.g., 2.2 seconds), regardless of the length of the input prompts. On the other hand, because the Second KV model 600 takes the input prompts and processes the input prompts, one token at a time, the first token latency may depend on the length of the input prompts (e.g., 100 milliseconds per token).

As discussed, an attention layer of the transformer may use a multi-head attention (MHA) mechanism to process and understand the input data in a parallel and comprehensive manner. The MHA mechanism improves the capabilities of a single-head attention (SHA) mechanism by allowing simultaneous processing across multiple heads. The core calculation for the SHA can be expressed as: Attention=V*softmax(Q*K^{T}), where the parameter Q represents queries, the parameter K represents keys, and the parameter V represents values. The MHA mechanism augments the SHA by introducing parallelism, allowing the transformer to simultaneously attend to different parts of the input, which can improve the transformer's ability to capture various aspects of the input data. Specifically, the SHA focuses on a single set (query, key, and value), and the MHA splits this focus across multiple sets, each set potentially capturing different contextual nuances from the input sequence.

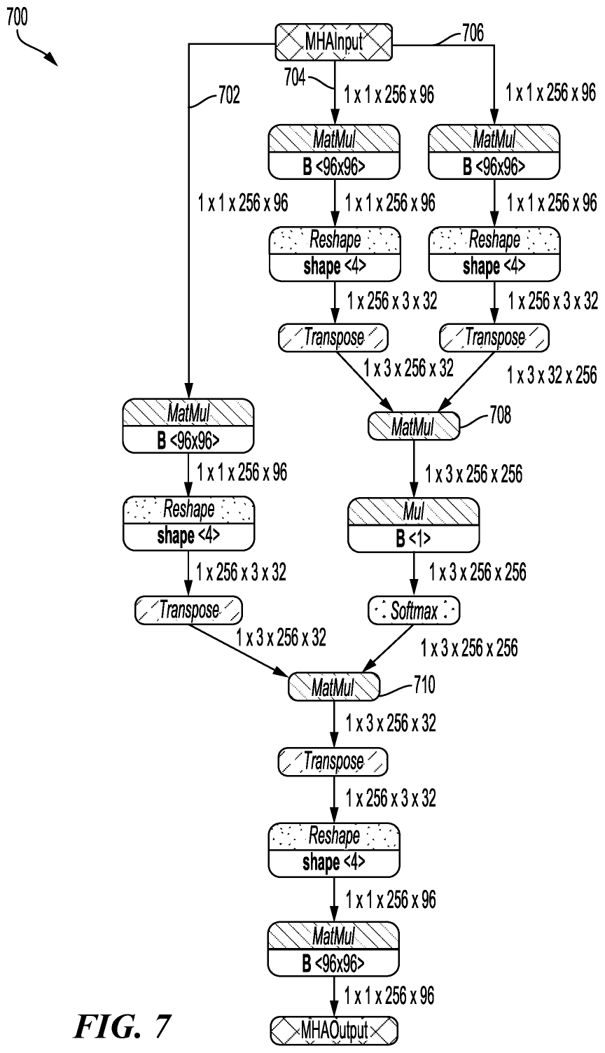

For example, in the context of natural language processing, each head may focus on different types of relationships between words, such as, for example, syntactic versus semantic relationships. This enables the transformer to have a more comprehensive understanding of the text. FIG. 7 is a flow diagram illustrating an example of a process 700 for processing an MHA input by an MHA mechanism of a transformer model, in accordance with various aspects of the present disclosure. The process 700 begins with an MHA input (shown as MHAInput) and ends with an MHA output (shown as MHAOutput).

In the example of FIG. 7, the MHA input may be an input tensor that is split into three paths 702, 704, 706 for parallel processing. The tensor of each path has a shape of 1×1×256×96. Each path 702, 704, 706 undergoes a first matrix multiplication operation 708 with a 96×96 matrix of shape, resulting in respective tensors with an unchanged shape of 1×1x256x96. Each tensor may then be reshaped to a new shape 1×256×3×32. In the first matrix multiplication operation 708, two tensors from paths 704 and 706 are transposed to 1×3×256×32 and a matrix multiplication (MatMul) operation is performed, resulting in a shape of 1×3×256×256. A multiplication (Mul) operation is performed, such that the tensor is multiplied element-wise with a broadcasted tensor with shape 1, resulting in a 1×3×256×256 tensor. A softmax operation is performed to normalize the scores in the attention mechanism.

At a first path 702, the reshaped tensor may be transposed to 1×3×256×32. A second matrix multiplication operation 710 is performed on the transposed tensor and the result of the softmax operation, resulting in a tensor with a shape of 1×3×256×32. The tensor is transposed back to 1×256×3×32 and then reshaped to 1×1×256×96. Finally, the tensor undergoes one more matrix multiplication with a 96×96 matrix, resulting in the MHA output with the same shape as the input tensor.

As shown in the example of FIG. 7, an input tensor undergoes a complex series of transformations and operations within the MHA, including reshaping, transposing, and various matrix multiplications. The process 700 culminates in the output tensor that may be used by subsequent layers in the model. Specifically, the process 700 may generate three vectors from the input data: queries (Q), keys (K), and values (V). The attention layer may use these vectors to create a set of attention scores based on comparing queries to keys. These scores, after being normalized using a softmax function, determine an amount of focus (e.g., attention) that should be given to corresponding values. The result is a weighted sum of the value vectors, which carries both the original information and the context obtained from the attention process. The model may simultaneously perform this operation based on the use of multiple heads.

As discussed, the MHA may reduce the efficiency of a neural signal processor (NSP), which processes neural network operations. The NSP may be an example of an NPU 108 described with reference to FIG. 1. In most cases, various computations of the MHA may be processed on specialized hardware cores within the NSP. For example, matrix multiplications may be assigned to a hardware core optimized for such operations, whereas the softmax function, which normalizes the attention weights, might be processed on a vector-processing core. The use of multiple specialized cores can lead to inefficiencies. The need to reshape and transpose data tensors for different stages of the MHA computation may also lead to additional computational overhead. These extra steps increase an amount of processing power and time specified for performing the attention operations, potentially slowing down the overall computation and reducing the throughput of the NSP. Furthermore, the increased complexity of managing data across different cores may increase power consumption and may necessitate more sophisticated hardware designs to maintain efficiency.

Various aspects of the present disclosure are directed to improving the MHA by splitting the MHA into individual SHA operations. In such aspects, each SHA operation may be executed independently to enable parallelization between hardware blocks, thereby reducing a number of reshape and transpose layers. In some examples, multiple single-head attention (SHA) operations may be specified instead of a single MHA operation. Each SHA operation may be associated with a head of the MHA. Additionally, each SHA may be executed independently, thereby increasing parallelization between different hardware blocks. The increased parallelization may reduce the dependency on specific cores for certain operations. Additionally, the increased parallelization may reduce a number of reshape and transpose layers, which may simplify the overall computation process.

In some examples, for quantized run-times that use per-tensor activation quantization, intermediate activations of each SHA may be quantized independently. This independent quantization may mitigate accuracy losses that may occur due to quantization, thus providing a more robust performance in quantized models. Quantization is a process that converts a continuous range of values (e.g., floating-point values) into a finite range of discrete values (e.g., integers), such that a machine learning model, such as a transformer model, may be implemented on hardware with limited precision.

In some conventional systems, a tensor may store the output of each attention head. That is, a tensor of size [number of heads, sequence length, depth] may be computed by the attention head. In contrast to conventional systems, a keys (K) tensor and values (V) tensors are split and stored independently for each head. That is, a number of head tensors having a size [sequence length, depth] may be written. This approach reduces the time data resides in memory and balances the memory use over time.

Autoregressive models are a type of neural network used in natural language processing and other sequential data tasks. These models generate predictions sequentially, meaning each new piece of output is conditioned on the previous outputs. In the context of language models, the autoregressive model may predict a next word in a sentence given all the previous words. In such models, a cache stores the keys (K) and values (V) tensors, which are internal representations of the input data generated during the inference process. When the autoregressive model makes a prediction, the model uses this cache to quickly access information about the previous parts of the sequence without having to recompute them from scratch. That is, the model reads the existing cache of tensors during inference and writes back the entire updated cache.

Autoregressive models generate one output at a time. Therefore, in some examples, only one new set of keys and values may be added to the cache with each inference step. That is, instead of updating and storing the entire cache after every single prediction, only the newly generated keys and values may be updated. This process may reduce demands on memory bandwidth and storage because the model is only saving the latest changes rather than rewriting the entire cache. It is akin to adding a new entry to a diary rather than rewriting the entire diary with each new event.

Moreover, in some such examples, cache maintenance may be delegated to a calling application. That is, the calling application using the model for inference takes control of the cache update process. By doing this, the amount of data to be transferred back and forth between the CPU and the NSP is reduced, thereby lowering overhead and reducing potential bottlenecks associated with moving large amounts of data.

Rotary positional encoding (RoPE) may be used in a transformer to integrate an order of tokens into the transformer's understanding of a sequence. Unlike conventional positional encodings that add a fixed vector to token embeddings, RoPE combines the token and positional encodings in a rotation-invariant way. This is performed using sine (Sin) and cosine (Cos) functions, which associate the position information to the token representations without the need for additive encoding vectors. The Sin and Cos functions used in RoPE are computationally intensive and are not particularly efficient when executed on quantized run-times. Quantized models may be useful for deployment on devices with limited processing power, such as mobile phones or Internet of Things (IoT) devices, where full-precision computations can be prohibitive.

To address this inefficiency, in some examples, the computation of ROPE embeddings may be offloaded to a CPU instead of processed on an NSP. The NSP is specialized hardware specified to accelerate neural network computations. The NSP may not be optimized for the type of operations associated with RoPE. By pre-computing RoPE tensors on the CPU for the next inference step while the current inference is still running on the NSP, the embeddings associated with the tensors may be ready when needed without introducing delays in the processing pipeline. This approach makes use of the CPU's capabilities to handle these specific mathematical operations more efficiently, thus not only conserving the NSP's resources but also streamlining the overall computation process.

The pre-computation process improves parallelism in the system's operation. For example, while the NSP is busy with one inference task, the CPU can work ahead, preparing the ROPE embeddings for subsequent tasks. This parallelization of tasks can improve throughput and reduce latency for transformer models.

In some cases, an attention mask may be specified in a transformer to focus on the transformer (e.g., the model) during the inference process, effectively guiding an attention mechanism to concentrate on certain parts of the input while ignoring others. This selective focus may be useful in tasks such as language translation or text generation. Each time an inference is made, the attention mask can change, adapting to the new input and context. This dynamic nature means that the attention mask may be recalculated for each step in the sequence generation. The recalculations often involve changing a datatype of the mask elements, which could be a conversion from integers to floating-point numbers or vice versa. These conversions can be resource-intensive and could slow down the processing on an NSP.

In some examples, to mitigate the computational overhead on the NSP, the attention masks may be pre-computed on the CPU. The CPU is generally more versatile and capable of managing control flow operations such as loops and conditional statements, which may be specified to generate these attention masks. Pre-computing attention masks on the CPU allows the NSP to remain dedicated to processing the deep learning operations. Meanwhile, the CPU handles the control flow logic that would otherwise impose additional complexity and processing time on the NSP. This division of labor streamlines the inference process and improves the overall efficiency of the model, thereby improving inference times.

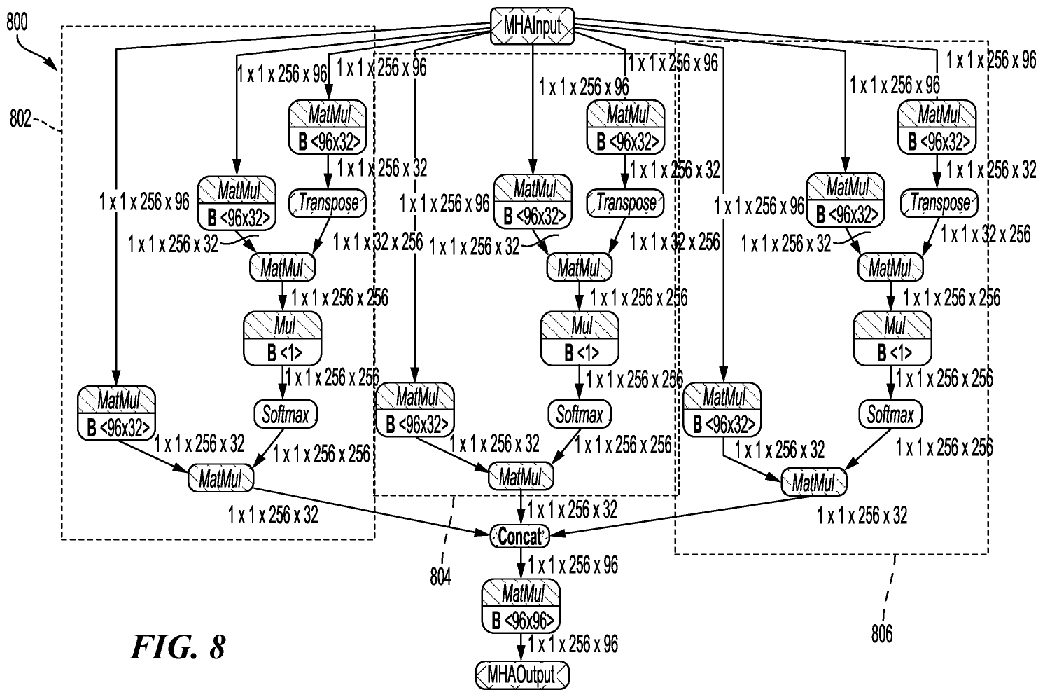

FIG. 8 is a flow diagram illustrating an example process 800 for parallelly processing an MHA input by multiple SHA mechanisms of a transformer model, in accordance with various aspects of the present disclosure. In the example of FIG. 8, an MHA mechanism is divided into multiple SHA mechanisms, each SHA mechanism corresponding to a head of the MHA mechanism, such as the MHA mechanism described with reference to FIG. 7. Each SHA mechanism is associated with a path 802, 804, 806. For ease of explanation, only three SHA paths are shown in the example of FIG. 8. Aspects of the present disclosure are not limited to three SHA paths.

The process 800 begins with an MHA input (shown as MHAInput) and ends with an MHA output (shown as MHAOutput). The input to the MHA begins as a four-dimensional tensor, having a size 1×1×256×96, which is then channeled into multiple SHAs, each operating in parallel. This segmentation allows the MHA to handle different portions of the input data independently, with each SHA performing its own set of computations.

In each SHA path 802, 804, 806, the initial step involves a matrix multiplication (MatMul) with a transformation matrix having a 96×32 shape, modifying the input data's shape (1×1×256×32) to facilitate further processing. In some paths, a transposing operation is performed on the output of the matrix multiplication to reshape the data to 1×1×32×256. The reshaped data may be multiplied with the output of another matrix multiplication to generate an output having a shape 1×1×256×256. A multiplication (Mul) operation is performed, such that the tensor is multiplied element-wise with a broadcasted tensor with shape 1, resulting in a 1×1×256×256 tensor. A softmax operation is performed to normalize the scores in the attention mechanism.

Following the softmax, the normalized scores are multiplied element-wise with the value vectors, allowing the model to assign the appropriate weight to each part of the input based on its contextual significance. The result is a tensor having a shape 1×1×256×32. The independently processed outputs from each SHA are then concatenated (Concat), merging the diverse perspectives each SHA has gleaned from the same input data. The concatenated output undergoes one last matrix multiplication, serving as a synthesis step to integrate the insights from each head.

The final output of this process is a tensor that retains the original input's shape, indicating a successful consolidation of the multiple attention perspectives into a unified representation. This output is processed through subsequent layers of the transformer.

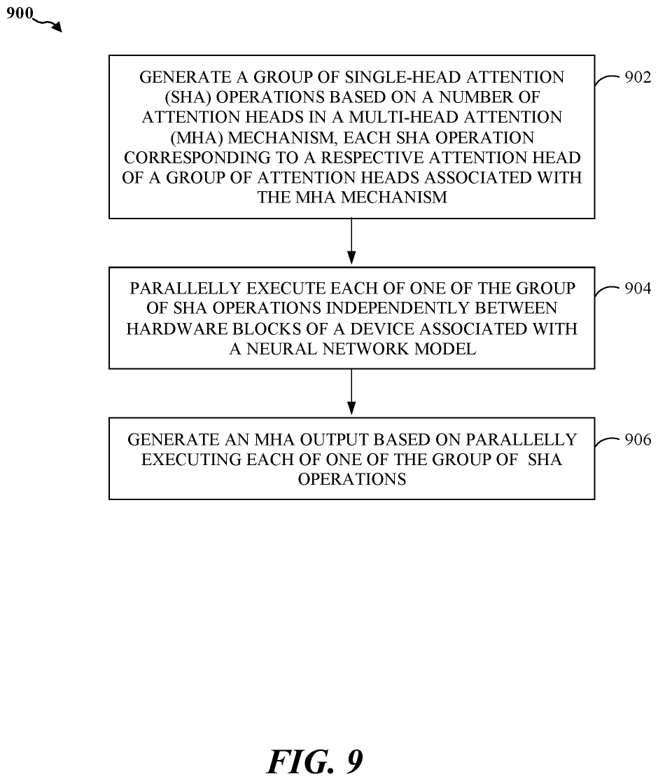

FIG. 9 is a flow diagram illustrating an example of a process 900 for generating multiple SHA mechanisms from an MHA associated with a transformer model, in accordance with various aspects of the present disclosure. The process 900 may be performed by one or more processors such as the CPU (e.g., 102, 422), GPU (e.g., 104, 426), and/or other processing unit (e.g., DSP 424, NPU 428), for example. The process 900 begins at block 902 by generating a group of single-head attention (SHA) operations based on a number of attention heads in a multi-head attention (MHA) mechanism, each SHA operation corresponding to a respective attention head of a group of attention heads associated with the MHA mechanism. At block 904, the process 900 parallelly executes each of one of the group of SHA operations independently between hardware blocks of a device associated with a neural network model. At block 906, the process 900 generates an MHA output based on parallelly executing each of one of the group of SHA operations.

Implementation examples are provided in the following numbered clauses.
Clause 1. A processor-implemented method comprising: generating a group of single-head attention (SHA) operations based on a number of attention heads in a multi-head attention (MHA) mechanism, each SHA operation corresponding to a respective attention head of a group of attention heads associated with the MHA mechanism; parallelly executing each of one of the group of SHA operations independently between hardware blocks of a device associated with a neural network model; and generating an MHA output based on parallelly executing each of one of the group of SHA operations.
Clause 2. The processor-implemented method of Clause 1, further comprising independently quantizing intermediate activations of each one of the group of SHA operation in a quantized runtime environment via per tensor activation quantization.
Clause 3. The processor-implemented method of any one of Clauses 1-2, further comprising: splitting key (K) tensors and value (V) tensors associated with outputs of the group of attention heads into a group of tensors, each one of the group of tensors corresponding to one attention head of the group of attention heads and having a dimensionality defined by sequence length and depth; and writing each one of the group of tensors to local memory.
Clause 4. The processor-implemented method of any one of Clauses 1-3, further comprising: reading, from a cache, existing tensors during inference; writing, to the cache, only a newest cache entry that is updated during the inference; and managing cache maintenance operations via a calling application so that the cache is accessible to one or more processors associated with the neural network model.
Clause 5. The processor-implemented method of any one of Clauses 1-4, further comprising precomputing Rotary Positional Encoding (RoPE) tensors on one or more central processing units (CPUs) associated with the neural network model while a current inference is executing on one or more neural network processors associated with the neural network model.
Clause 6. The method of any one of Clauses 1-5, further comprising: precomputing one or more attention masks; and applying the one or more attention masks during inference, wherein each of the one or more attention masks changes with each inference.
Clause 7. An apparatus comprising a processor, memory coupled with the processor, and instructions stored in the memory and operable, when executed by the processor to cause the apparatus to perform any one of Clauses 1 through 6.
Clause 8. An apparatus comprising at least one means for performing any one of Clauses 1 through 6.
Clause 9. A computer program comprising code for causing an apparatus to perform any one of Clauses 1 through 6.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer- readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A processor-implemented method comprising:
generating a group of single-head attention (SHA) operations based on a number of attention heads in a multi-head attention (MHA) mechanism, each SHA operation corresponding to a respective attention head of a group of attention heads associated with the MHA mechanism;
parallelly executing each of one of the group of SHA operations independently between hardware blocks of a device associated with a neural network model; and
generating an MHA output based on parallelly executing each of one of the group of SHA operations.

2. The processor-implemented method of claim 1, further comprising independently quantizing intermediate activations of each one of the group of SHA operation in a quantized runtime environment via per tensor activation quantization.

3. The processor-implemented method of claim 1, further comprising:
splitting key (K) tensors and value (V) tensors associated with outputs of the group of attention heads into a group of tensors, each one of the group of tensors corresponding to one attention head of the group of attention heads and having a dimensionality defined by sequence length and depth; and
writing each one of the group of tensors to local memory.

4. The processor-implemented method of claim 1, further comprising:
reading, from a cache, existing tensors during inference;
writing, to the cache, only a newest cache entry that is updated during the inference; and
managing cache maintenance operations via a calling application so that the cache is accessible to one or more processors associated with the neural network model.

5. The processor-implemented method of claim 1, further comprising precomputing Rotary Positional Encoding (RoPE) tensors on one or more central processing units (CPUs) associated with the neural network model while a current inference is executing on one or more neural network processors associated with the neural network model.

6. The processor-implemented method of claim 1, further comprising:
precomputing one or more attention masks; and
applying the one or more attention masks during inference, wherein each of the one or more attention masks changes with each inference.

7. An apparatus, comprising:
means for generating a group of single-head attention (SHA) operations based on a number of attention heads in a multi-head attention (MHA) mechanism, each SHA operation corresponding to a respective attention head of a group of attention heads associated with the MHA mechanism;
means for parallelly executing each of one of the group of SHA operations independently between hardware blocks of a device associated with a neural network model; and
means for generating an MHA output based on parallelly executing each of one of the group of SHA operations.

8. The apparatus of claim 7, further comprising means for independently quantizing intermediate activations of each one of the group of SHA operation in a quantized runtime environment via per tensor activation quantization.

9. The apparatus of claim 7, further comprising:
means for splitting key (K) tensors and value (V) tensors associated with outputs of the group of attention heads into a group of tensors, each one of the group of tensors corresponding to one attention head of the group of attention heads and having a dimensionality defined by sequence length and depth; and
means for writing each one of the group of tensors to local memory.

10. The apparatus of claim 7, further comprising:
means for reading, from a cache, existing tensors during inference;
means for writing, to the cache, only a newest cache entry that is updated during the inference; and
means for managing cache maintenance operations via a calling application so that the cache is accessible to one or more processors associated with the neural network model.

11. The apparatus of claim 7, further comprising means for precomputing Rotary Positional Encoding (RoPE) tensors on one or more central processing units (CPUs) associated with the neural network model while a current inference is executing on one or more neural network processors associated with the neural network model.

12. The apparatus of claim 7, further comprising:
means for precomputing one or more attention masks; and
means for applying the one or more attention masks during inference, wherein each of the one or more attention masks changes with each inference.

13. An apparatus, comprising:
one or more processors; and
one or more memories coupled with the one or more processors and storing instructions operable, when executed by the one or more processors, to cause the apparatus to:
generate a group of single-head attention (SHA) operations based on a number of attention heads in a multi-head attention (MHA) mechanism, each SHA operation corresponding to a respective attention head of a group of attention heads associated with the MHA mechanism;
parallelly execute each of one of the group of SHA operations independently between hardware blocks of a device associated with a neural network model; and
generate an MHA output based on parallelly executing each of one of the group of SHA operations.

14. The apparatus of claim 13, wherein execution of the instructions further cause the apparatus to independently quantize intermediate activations of each one of the group of SHA operation in a quantized runtime environment via per tensor activation quantization.

15. The apparatus of claim 13, wherein execution of the instructions further cause the apparatus to:
split key (K) tensors and value (V) tensors associated with outputs of the group of attention heads into a group of tensors, each one of the group of tensors corresponding to one attention head of the group of attention heads and having a dimensionality defined by sequence length and depth; and
write each one of the group of tensors to local memory.

16. The apparatus of claim 13, wherein execution of the instructions further cause the apparatus to:
read, from a cache, existing tensors during inference;
write, to the cache, only a newest cache entry that is updated during the inference; and
manage cache maintenance operations via a calling application so that the cache is accessible to one or more processors associated with the neural network model.

17. The apparatus of claim 13, wherein execution of the instructions further cause the apparatus to precompute Rotary Positional Encoding (RoPE) tensors on one or more central processing units (CPUs) associated with the neural network model while a current inference is executing on one or more neural network processors associated with the neural network model.

18. The apparatus of claim 13, wherein execution of the instructions further cause the apparatus to:
precompute one or more attention masks; and
apply the one or more attention masks during inference, wherein each of the one or more attention masks changes with each inference.

19. A non-transitory computer-readable medium having program code recorded thereon, the program code executed by one or more processors and comprising:
program code to generate a group of single-head attention (SHA) operations based on a number of attention heads in a multi-head attention (MHA) mechanism, each SHA operation corresponding to a respective attention head of a group of attention heads associated with the MHA mechanism;
program code to parallelly execute each of one of the group of SHA operations independently between hardware blocks of a device associated with a neural network model; and
program code to generate an MHA output based on parallelly executing each of one of the group of SHA operations.

20. The non-transitory computer-readable medium of claim 19, wherein the program code further comprises program code to independently quantize intermediate activations of each one of the group of SHA operation in a quantized runtime environment via per tensor activation quantization.

21. The non-transitory computer-readable medium of claim 19, wherein the program code further comprises:
program code to split key (K) tensors and value (V) tensors associated with outputs of the group of attention heads into a group of tensors, each one of the group of tensors corresponding to one attention head of the group of attention heads and having a dimensionality defined by sequence length and depth; and
program code to write each one of the group of tensors to local memory.

22. The non-transitory computer-readable medium of claim 19, wherein the program code further comprises:
program code to read, from a cache, existing tensors during inference;
program code to write, to the cache, only a newest cache entry that is updated during the inference; and
program code to manage cache maintenance operations via a calling application so that the cache is accessible to one or more processors associated with the neural network model.

23. The non-transitory computer-readable medium of claim 19, wherein the program code further comprises program code to precompute Rotary Positional Encoding (RoPE) tensors on one or more central processing units (CPUs) associated with the neural network model while a current inference is executing on one or more neural network processors associated with the neural network model.

24. The non-transitory computer-readable medium of claim 19, wherein the program code further comprises:
program code to precompute one or more attention masks; and
program code to apply the one or more attention masks during inference, wherein each of the one or more attention masks changes with each inference.
